(19) United States
(12) Patent Application Publication
(10) Pub. No.: US 2010/0312386 A1
(43) Pub. Date: Dec. 9, 2010

(54) TOPOLOGICAL-BASED LOCALIZATION AND NAVIGATION

(75) Inventors: Georgios Chrysanthakopoulos, Seattle, WA (US); Guy Shani, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/477,915

(22) Filed: Jun. 4, 2009

(51) Int. Cl. G05B 19/042; G06K 9/00

(52) U.S. Cl. 700/246; 382/103; 901/1; 901/47

(57) ABSTRACT

Functionality is described for probabilistically determining the location of an agent within an environment. The functionality performs this task using a topological representation of the environment provided by a directed graph. Nodes in the directed graph represent locations in the environment, while edges represent transition paths between the locations. The functionality also provides a mechanism by which the agent can navigate in the environment based on its probabilistic assessment of location. Such a mechanism can use a high-level control module and a low-level control module. The high-level control module determines an action for the agent to take by considering a plurality of votes associated with different locations in the directed graph. The low-level control module allows the agent to navigate along a selected edge when the high-level control module votes for a navigation action.

### BACKGROUND

A variety of mechanisms have been proposed which allow an agent (such as a robot) to determine its location within an environment and to navigate within that environment. In an approach referred to as Simultaneous Localization and Mapping (SLAM), the agent builds a map of the environment in the course of navigation within that environment. In the SLAM approach, the agent may receive information from various sensors, including visual sensors.

There remains room for considerable improvement in known localization and navigation mechanisms. For example, many mechanisms attempt to build a map of the environment that accurately reflects the actual distances between features in the physical environment. Such a map is referred to as a metric-accurate map. However, these types of mechanisms may be relatively complex in design, and may offer unsatisfactory performance.

### SUMMARY

Functionality is described for performing localization and navigation within an environment using a topological approach. In this approach, the agent (or some other entity) generates a directed graph which represents the environment. The directed graph includes nodes that represent locations within the environment and edges which represent transition paths between the locations. The directed graph need not represent features within the physical environment in a literal (e.g., metric-accurate) manner.

The functionality operates by generating observations associated with the agent's current interaction with the environment. The observations may reflect, for instance, an extent to which an input image captured by the agent matches graph images associated with the directed graph. The functionality then generates probabilistic beliefs based on the observations. The probabilistic beliefs identify the likelihood that the agent is associated with different respective locations identified by the directed graph. The functionality can also perform navigation within the environment based on the probabilistic beliefs.

According to one illustrative aspect, the functionality uses system dynamics to generate the probabilistic beliefs. That is, the functionality can generate the probabilistic beliefs in a manner which takes account of the movement of the agent within the environment, together with the structure of the environment itself. This operation serves a filtering role, discounting certain possibilities based on the system dynamics.

In one illustrative approach, the functionality can include a high-level control module and a low-level control module. The high-level control module generates a plurality of votes associated with different respective locations in the directed graph. The votes identify different actions that the agent may take, such as “do nothing” (in which the agent takes no action), rotate, navigate, and explore. The high-level control module weights each of the votes by the above-identified probabilistic beliefs, and based thereon, selects an action that is considered to be the most appropriate action. The low-level control module can also take into consideration costs associated with different locations in the directed graph in making its selection.

The low-level control module is invoked when the high-level control module selects a navigate action. The low-level control module governs the movement of the agent along a transition path associated with an edge in the directed graph. In operation, the low-level control module can determine the location of the agent along the edge in a probabilistic manner that takes account of system dynamics, such as the motion of the agent. The low-level control module can also correlate the position of the agent to a location of the agent along a transition path (corresponding to the edge) based on an analysis of sequence numbers or the like assigned to images associated with the edge.

The low-level control module can also determine, in a probabilistic fashion, the manner in which a current input image differs from edge images associated with the edge. This yields an offset by which the movement of the agent can be controlled along the transition path associated with the edge.

According to another illustrative aspect, the functionality can include a learning mechanism for adding new edges to the directed graph as the agent performs successful navigation within the environment. Based on such performance, the functionality can also update transition information that defines the system dynamics. At any time, the functionality can also perform maintenance on the graph. The maintenance may include removing redundant edges, adding new juncture points, etc.

According to another illustrative aspect, the agent receives a plurality of input images provided by the agent within an environment, including: a front image provided by the agent associated with a visual field in view in front of the agent; a back image provided by the agent associated with a visual field of view in back of the agent; and depth-related information provided by the agent that identifies distances between features in the environment and the agent. In forming the observations, the agent is operative to select between the front image and the back image based on a determined suitability of the front image and the back image. The suitability of the front image with respect to the back image is based on a determination of whether the agent is at a node location or an edge location (because the front image may be obscured when at an edge location). The agent can use the depth information as a validity check on comparison results obtained using either the front image or the back image.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an overview of an illustrative agent that can perform localization and navigation using a visual topology approach.

FIG. 2 shows an illustrative sensing system that can be used by the agent of FIG. 1.

FIG. 3 shows one illustrative initial training module that can be used by the agent of FIG. 1.

FIG. 4 shows an illustrative environment in which the agent of FIG. 1 can operate.

FIG. 5 shows an illustrative transition path that connects two locations within the environment of FIG. 4, together with images taken over the transition path.

FIG. 6 is a graphical demonstration of the image-capturing behavior of the agent of FIG. 1 as it moves through a corner.

FIG. 7 shows an illustrative directed graph that topologically represents features within the environment of FIG. 4.

FIG. 8 shows an illustrative high-level control module for determining the location of the agent within an environment and for identifying an action to be performed by the agent at any particular instance of time.

FIG. 9 shows transition information that can be used by the high-level control module of FIG. 8 in performing its functions.

FIG. 10 is a graphical depiction of votes generated by the high-level control module of FIG. 8, the votes being associated within different respective locations within a directed graph.

FIG. 11 shows an illustrative low-level control module for determine the location of the agent along an edge in the directed graph, and for advancing the agent along that edge.

FIG. 12 is a graphical depiction of probabilistic beliefs generated by the low-level control module of FIG. 11, the probabilistic beliefs identifying the likelihood of the agent being present at different locations along an edge.

FIG. 13 is a graphical depiction of a comparison, performed by the low-level control module of FIG. 11, of a current image with images associated with an edge.

FIG. 14 is a graphical depiction of a manner in which the agent can be controlled on the basis of an offset which is generated as a result of the comparison shown in FIG. 13.

FIG. 15 shows an illustrative graph updating module that can be used in the agent of FIG. 1.

FIG. 16 is a graphical depiction of a manner in which the graph updating module of FIG. 15 can add a new juncture point to a directed graph.

FIG. 17 shows an illustrative procedure that provides an overview of a training operation performed by the agent of FIG. 1.

FIG. 18 shows an illustrative procedure that describes a manual manner of training the agent of FIG. 1.

FIG. 19 shows an illustrative procedure that describes a high-level controlling operation performed by the agent of FIG. 1.

FIG. 20 shows an illustrative procedure that describes an action-selection aspect of the high-level controlling operation of FIG. 19.

FIG. 21 shows an illustrative procedure that describes a belief update operation that can be performed by the agent of FIG. 1; this belief update operation can be performed in the context of locations (by the high-level control module) or images (by the low-level control module).

FIG. 22 shows an example of high-level transition information that can be used by the high-level control module of FIG. 8.

FIG. 23 shows an illustrative procedure that describes a multi-hop selection operation, which is a specific operation encompassed by the high-level controlling operation of FIGS. 19 and 20.

FIG. 24 shows an illustrative procedure that describes an explore-mode selection operation, which is another specific operation encompassed by the high-level controlling operation of FIGS. 19 and 20.

FIG. 25 shows an illustrative procedure that describes a low-level controlling operation performed by the agent of FIG. 1.

FIGS. 26-27 show an example of low-level transition information that can be used by the low-level control module of FIG. 11.

FIG. 28 shows an illustrative procedure that describes an offset determination operation, which is part of the low-level controlling operation of FIG. 25.

FIG. 29 shows an illustrative procedure that describes a graph updating operation performed by the agent of FIG. 1.

FIG. 30 shows illustrative processing functionality that can be used to implement any aspect of the features shown in the foregoing drawings.

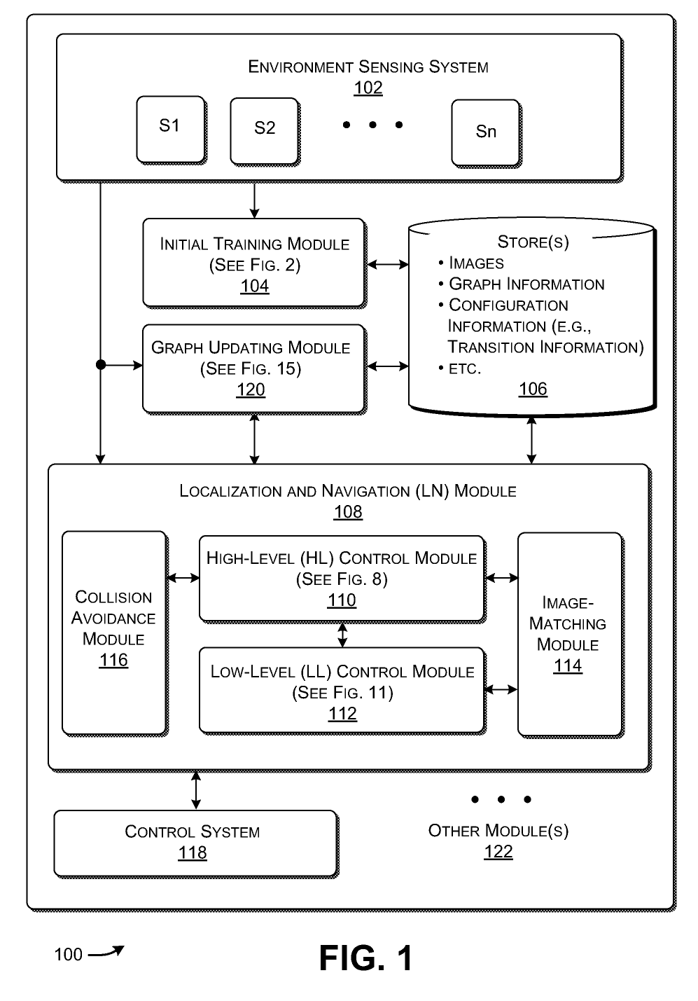

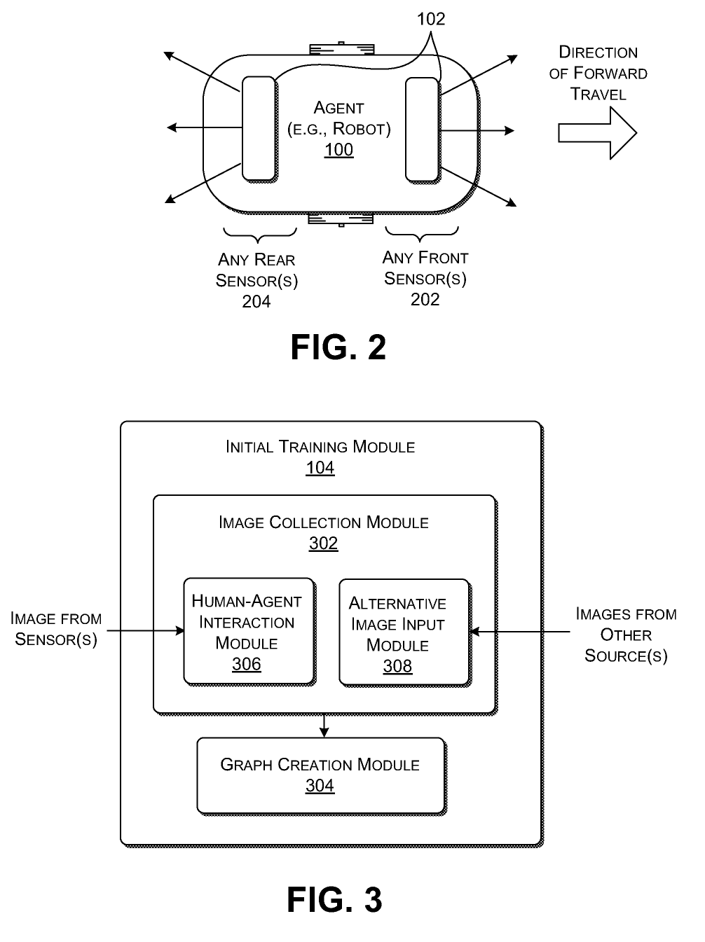

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure sets forth functionality for determining a location of an agent (such as a robot) within an environment using a probabilistic topological approach. The disclosure also describes functionality for performing navigation within the environment using the probabilistic topological approach.

This disclosure is organized as follows. Section A describes an illustrative agent that incorporates the functionality summarized above. Section B describes illustrative methods which explain the operation of the agent. Section C describes illustrative processing functionality that can be used to implement any aspect of the features described in Sections A and B.

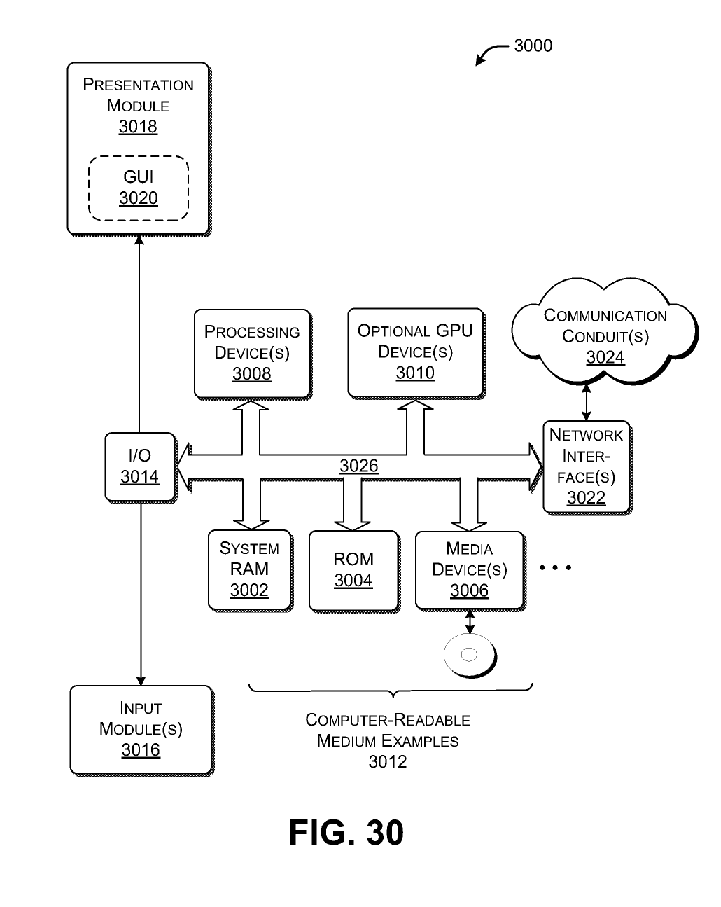

As a preliminary matter, some of the figures describe concepts in the context of one or more structural components, variously referred to as functionality, modules, features, elements, etc. The various components shown in the figures can be implemented in any manner, for example, by software, hardware (e.g., discrete logic components, etc.), firmware, and so on, or any combination of these implementations. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component. FIG. 30, to be discussed in turn, provides additional details regarding one illustrative implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented by software, hardware (e.g., discrete logic components, etc.), firmware, manual processing, etc., or any combination of these implementations.

As to terminology, the phrase “configured to” encompasses any way that any kind of functionality can be constructed to perform an identified operation. The functionality can be configured to perform an operation using, for instance, software, hardware (e.g., discrete logic components, etc.), firmware etc., and/or any combination thereof.

The term “logic” encompasses any functionality for performing a task. For instance, each operation illustrated in the flowcharts corresponds to logic for performing that operation. An operation can be performed using, for instance, software, hardware (e.g., discrete logic components, etc.), firmware, etc., and/or any combination thereof.

A. Illustrative Systems

A. 1. Overview of and Illustrative Agent

FIG. 1 shows an agent 100 for performing probabilistic-based localization and navigation within an environment. In one case, the agent 100 corresponds to any type of robot or automated vehicle for performing any task in any context. For example, such a robot or automated vehicle can be used in consumer applications, manufacturing applications, law enforcement applications, scientific applications, and so on. In another case, the agent 100 may correspond to a device that can be carried by a human or otherwise operated by a human. For example, the agent 100 may correspond to a location-finding device that identifies a probable location of a human within an environment.

Likewise, the term environment should be liberally construed as used herein. In one case, the environment may correspond to an indoor setting, such as a house, an apartment, a manufacturing plant, and so on. In another case, an environment may correspond to an outdoor setting of any geographic scope.

The agent 100 operates by probabilistically determining its location using a directed graph. To that end, the agent includes a sensing system 102 and an initial training module 104. The sensing system 102 includes one or more sensors (S1, S2, . . . Sn) for providing input information regarding the environment. The initial training module 104 can use the input information to construct a directed graph that represents the environment. (As will be discussed below, the agent 100 can alternatively construct the directed graph based on information obtained from other sources.) The directed graph includes a collection of nodes that represent locations in the environment. The directed graph also includes a collection of edges that represent transition paths between the locations.

In general, the directed graph represents the environment in a topological manner, rather than a metric-accurate manner. As such, there is no requirement that distances between the nodes in the directed graph represent actual distances among physical features in the environment. Additional details will be provided below regarding the operation of the initial training module 104, e.g., in connection with FIGS. 3-7. The initial training module 104 can store input information and graph-related information in a store 106.

A localization and navigation (LN) module 108 performs two main tasks. First, the LN module 108 determines the location of the agent within the environment in a probabilistic manner. In operation, the LN module 108 generates a plurality of probabilistic belief (“beliefs”) that identify the likelihood that the agent is associated with different locations identified in the directed graph. This means that, at any given time, the LN module 108 can identify the location of the agent using a probability density function, rather than specifying the physical coordinates (e.g., Cartesian coordinates) of the agent 100 within the environment. Further, the LN module 108 can use probabilistic techniques to assess the location of the agent along a particular transition path.

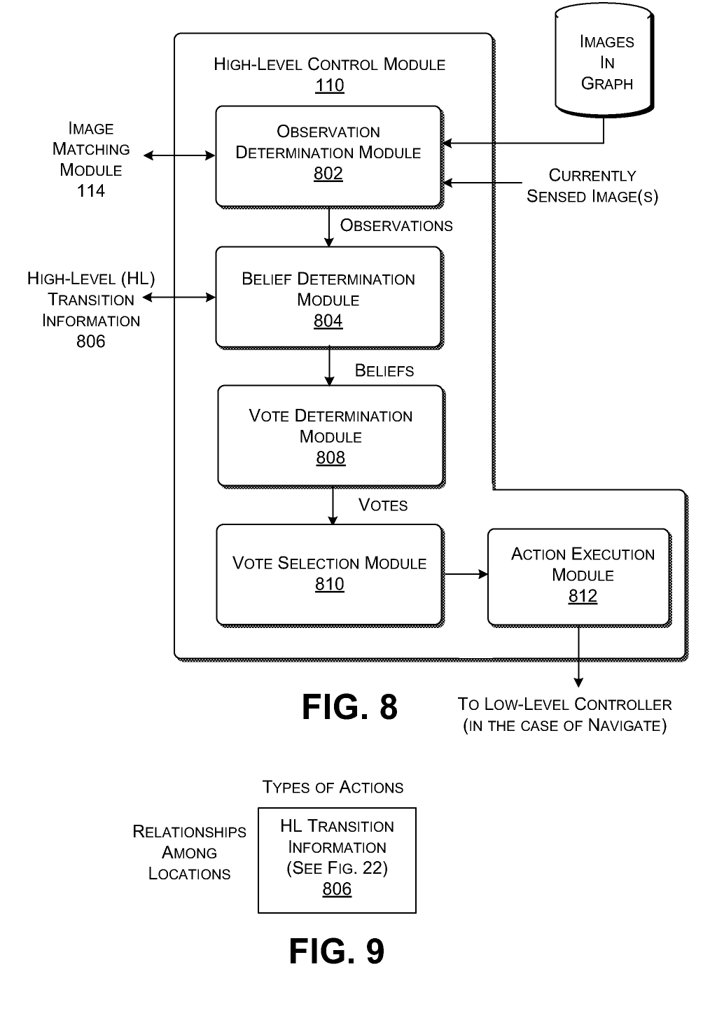

Second, the LN module 108 can allow the agent 100 to navigate through the environment based on its probabilistic assessment of location. To this end, the LN module 108 includes a high-level (HL) control module 110 and a low-level (LL) control module 112. The HL control module 110 identifies a plurality of votes for different respective locations within the directed graph. The votes make different respective recommendations for actions to be taken, based on the “perspective” of different locations in relation to a destination location being sought. The HL control module 110 modifies the votes by the above-described probabilistic beliefs (and, in some cases, cost information) to provide weighted votes. The HL control module 110 then selects an action based on a consideration of the weighted votes. Illustrative actions include “do nothing” (in which the agent 100 takes no action), rotate (in which the agent 100 rotates in place at a particular location), navigate (in which the agent 100 navigates along a transition path), and explore (in which the agent 100 moves throughout the environment without regard to a destination location). Additional details will be provided below regarding the operation of the initial HL control module 110, e.g., in connection with FIGS. 8-10.

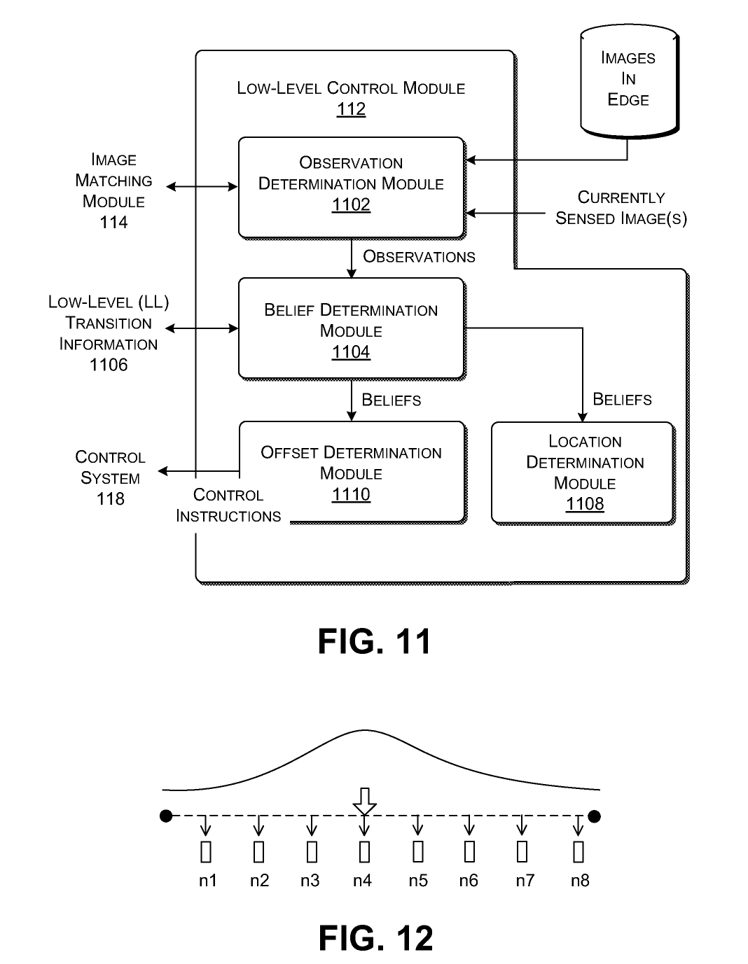

The LL control module 112 executes a navigate action, if that action is chosen by the HL control module 110. In doing so, the LL control module 112 can determine, in a probabilistic manner, an offset between a current input image and a collection of images associated with an edge in the directed graph. The LL control module 112 can then use the offset to advance the agent 100 along a transition path associated with the edge. Additional details will be provided below regarding the operation of the LL control module 112, e.g., in connection with FIGS. 11-14.

In performing the above-described tasks, the LN module 108 may rely on an image matching module 114. The image matching module 114 assesses the similarity between an input image and any image associated within the directed graph, referred to herein as a graph image. The imaging matching module 114 can perform this matching operation using any technique. For example, the imaging matching module 114 can identify features associated with the input image and determine the extent to which these features match features associated with a graph image. In one non-limiting example, the image matching module 114 can use the image matching technique described in copending and commonly assigned U.S. application Ser. No. 12/435,447, entitled “Efficient Image Matching,” filed on May 5, 2009, naming Georgios Chrysanthakopoulos as inventor. In that approach, matching is performed by first comparing one or more global signatures associated with the input image within global signatures associated with a collection of previously stored images. This fast comparison produces a subset of previously stored images that are possible matches for the input image. The approach then performs matching on a higher granularity by comparing features within the input image and features within the subset of previously images. However, any other image matching algorithm can also be used, such as a standard Harris-type feature comparison algorithm without the use of global signatures, etc.

The LN module 108 also interacts with a collision avoidance module 116. The collision avoidance module 116 receives input information, such as depth-related information, from the sensing system 102. Based on this input information, the collision avoidance module 116 determines the presence of obstacles in the path of the agent 100. The LN module 108 uses information provided by the collision avoidance module 116 to govern the movement of the agent 100 so that it does not collide with the obstacles.

A control system 118 receives actuation instructions from the LN module 108. The control system 118 uses these instructions to govern the movement of the agent 100. For example, the control system 118 may use the instructions to control one or more motors that are used to move the agent 100 along a desired path.

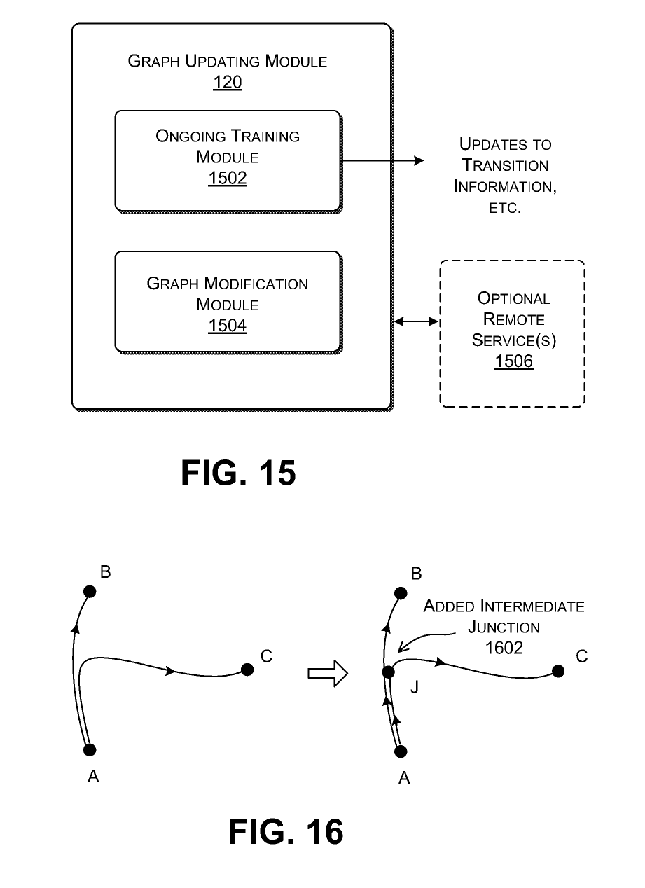

A graph updating module 120 is used to modify the directed graph and associated configuration information on an ongoing basis. The graph updating module 120 thereby allows the agent 100 to learn its environment in the course of its use. For example, the graph updating module 120 can add edges to the directed graph in response to instances in which the agent 100 has successfully navigated between locations in the environment. In addition, or alternatively, the graph updating module 120 can modify configuration information (such as transition information, to be discussed) based on navigation that it has performed. In addition, or alternatively, the graph updating module 120 can prune redundant information within the directed graph or make other maintenance-related modifications. In addition, or alternatively, the graph updating module 120 can add new juncture points to the directed graph. The graph updating module 120 can perform other modification-related tasks. Additional details will be provided below regarding the operation of the graph updating module 120, e.g., in connection with FIGS. 15-16.

Finally, FIG. 1 indicates that the agent 100 can include other modules 122, not specifically enumerated in this figure. For example, the agent 100 can include charging functionality that allows it to be recharged when it is coupled to a charging station (not shown). The agent 100 can automatically navigate to the charging station based on a beacon signal (e.g., a radio frequency beacon signal) transmitted by the charging station.

A.2. Illustrative Sensing System and Image Matching Module

FIG. 2 shows additional details regarding the sensing system 102 of the agent 100. In this figure, the agent 100 corresponds to a robot which moves over an environment by virtue of wheels powered by one or more motors. This type of agent 100 is merely representative. Other types of agents can use other means of locomotion. Likewise, the sensing system 102 itself is representative of one of many different types of sensing systems that can be used by an agent 100.

The sensing system 102 collects input information using one or more sensors. In one case, the sensors can collect the input information at fixed temporal intervals. Alternatively, or in addition, the sensors can provide input information on an event-driven basis. The input information can have any resolution (including relatively low resolution), size, formatting, chromatic content (or lack thereof), etc.

The sensors can use different sensing mechanisms to receive information from the environment. For example, a first type of sensor can provide visual images in a series of corresponding frames. A second type of sensor can provide depth-related information, e.g., using an infrared mechanism, a visual mechanism, etc. The depth information reflects distances between features in the environment and the agent 100. A third type of sensor can receive any kind of beacon signal or the like, e.g., using a radio frequency mechanism, etc. A fourth type of sensor can receive sound information. The sensors can include yet other types of sensing mechanisms. To facilitate discussion, the input information provided by any sensor or collection of sensors at an instance of time is referred to herein as an image. In the case of a visual sensor, the image may correspond to a two-dimensional array of visual information, defining a single frame.

The agent 100 may arrange the sensors to receive different fields of view. In one merely illustrative case, the agent 100 can include one or more front sensors 202 which capture a front field of view of the agent 100. In another words, this field of view is pointed in the direction of travel of the agent 100. The agent 100 can also include one or more back sensors 204 which capture a back field of view of the agent 100. This field of view is generally pointed 180 degrees opposite to the direction of travel of the agent 100. The agent 100 may employ other sensors in other respective locations (not shown). In one illustrative case, the front sensors 202 can receive a front visual image and a front depth image, while the back sensors 204 can receive a back visual image.

The agent 100 can link together different types of images that are taken at the same time. For example, at a particular location and at a particular instance of time, the sensing system 102 can take a front image, a back image, and a depth image. The agent 100 can maintain these three images in the store 106 as a related collection of environment-related information.

The image matching module 114 can process linked images in different ways depending on different contextual factors. Consider a first illustrative case in which the agent 100 provides only a single input image of any type for a particular location. Having no other information, the image matching module 114 uses this lone image in attempt to identify matching graph images that have been previously stored.

Consider next the illustrative case in which the agent 100 provides both a front visual image and a back visual image at a non-transition (non-edge) location within the environment, such as a bedroom within a house. Here, the imaging matching module 114 uses the front image to identify one or more matching graph images, with associated matching confidences. The image matching module 114 also uses the back image to identify one or more graph images, with associated matching confidences. The image matching module 114 can then decide to use whichever input image produces the matching graph images having the highest suitability (e.g., confidence) associated therewith.

Consider next the illustrative case in which the agent 100 provides a front visual image and a back visual image corresponding to a location along a transition path. Here, the image matching module 114 again uses the front image and the back image to generate respective sets of matching graph images. But here the image matching module 114 may be configured to favor the use the back image. This is because, in the training phase, the human user may be partially obstructing the field of view of the front image (in a manner to be discussed below). Hence, even if the front image produces matching graph images of high confidence, the image matching module 114 may select the back image over the front image. Different applications can adopt different rules to define the circumstances in which a back image will be favored over a front image.

Consider next the illustrative case in which the agent 100 provides a depth image in addition to either the front image or the back image, or in addition to both the front image and the back image. In one case, an input depth image can be compared to other pre-stored depth images associated with the directed graph. The input depth image and/or its matching pre-stored depth images also convey information when considered with respect to visual images that have been taken at the same time as the depth images. For example, the image matching module 114 can use a complementary depth image as a validity check on the matching graph images identified using any visual image. For example, assume that the image matching module 114 uses a visual image to identify a matching graph image associated with location X, yet the depth information (e.g., the input depth image and/or its matching pre-stored depth images) reveals that the agent 100 is unlikely to be in the vicinity of location X. The image matching module 114 can therefore use the depth information to reject the matching graph image associated with location X. In its stead, the imaging matching module 114 can decide to use another matching graph image which is more compatible with the depth information. This other matching graph image can be selected based on a visual image (front and/or back), as guided or constrained by the depth information; or the matching graph image can be selected based on an input depth image alone. Other types of input information can serve as validity check in the above-described manner, such as a Wi-Fi signal or the like that has different signal strength throughout the environment.

The above framework for processing images of different types is representative and non-limiting. Other systems can use other rules to govern the processing of images of different types.

The image matching module 114 can compare visual images using one or more techniques. For instance, the image matching module 114 can compute one or more global signatures for an input image and compare the global signatures to previously-stored global signatures associated with images within the directed graph. A global signature refers to information which characterizes an image as a whole, as opposed to just a portion of the image. For example, a global signature can be computed based on any kind of detected symmetry in an image (e.g., horizontal, and/or vertical, etc.), any kind of color content in the image (e.g., as reflected by color histogram information, etc.), any kind of detected features in the image, and so on. In the last-mentioned case, a global signature can represent averages of groups of features in an image, standard deviations of groups of features in the image, and so on. Alternatively, or in addition, the image matching module 114 can perform comparison on a more granular level by comparing individual features in the input image with features of previously-stored images.

The image matching module 114 can also compare depth images using various techniques. A depth image can be represented as a grayscale image in which values represent depth (with respect to an origin defined by the agent 100). In one representative and non-limiting case, for instance, the value 0 can represent zero distance and the value 255 can represent a maximum range (where the actual maximum range depends on the type of camera being used). Values between 0 and 255 represent some distance between zero and the maximum range. In one case, the image matching module 114 can create a single row for a depth image, where each value in the row represents a minimum depth reading for a corresponding column in the image. This row constitutes a depth profile that can serve as a global signature. Alternatively, or in addition, the image matching module 114 can take the horizontal and/or vertical gradients of the depth image and use the resultant information as another global signature. Alternatively, or in addition, the image matching module 114 can apply any of the visual matching techniques described in the preceding paragraph for depth images. The image matching module 114 can rely on yet other techniques for comparing depth images; the examples provided above are non-exhaustive.

A.3. Illustrative Initial Training Module

FIG. 3 shows additional details of the initial training module 104 introduced in FIG. 1. The initial training module 104 operates in a boot-up phase to learn the characteristics of the environment in which the agent 100 is to subsequently operate in a real-time mode. The initial training module 104 represents the characteristics of the environment using a directed graph having a collection of nodes and edges.

To perform its operation, the initial training module 104 can include (or can be conceptualized as including) an image collection module 302 and a graph creation module 304. The image collection module 302 receives images from the sensing system 102. The images represent the characteristics of the environment. The graph creation module 304 organizes the images collected by the image collection module 302 into the directed graph.

Beginning with the image collection module 302, the agent 100 can learn its environment in different ways. To illustrative this point, FIG. 3 shows that the image collection module 302 may include a human-agent interaction module 306 and an alternative image input module 308. The human-agent interaction module 306 includes functionality which allows a user to guide the agent 100 through an operating environment. In the course of this tour, the agent 100 captures images of different locations and transition paths between the different locations. The alternative image input module 308 includes functionality which allows the agent 100 (or other entity) to receive a collection of images from any other source. For example, a user may manually take pictures of an environment in conventional fashion, e.g., using a still image camera or video camera. The user may then group the pictures into folders associated with respective locations and folders associated with respective transition paths. Still other approaches can be used to obtain the images.

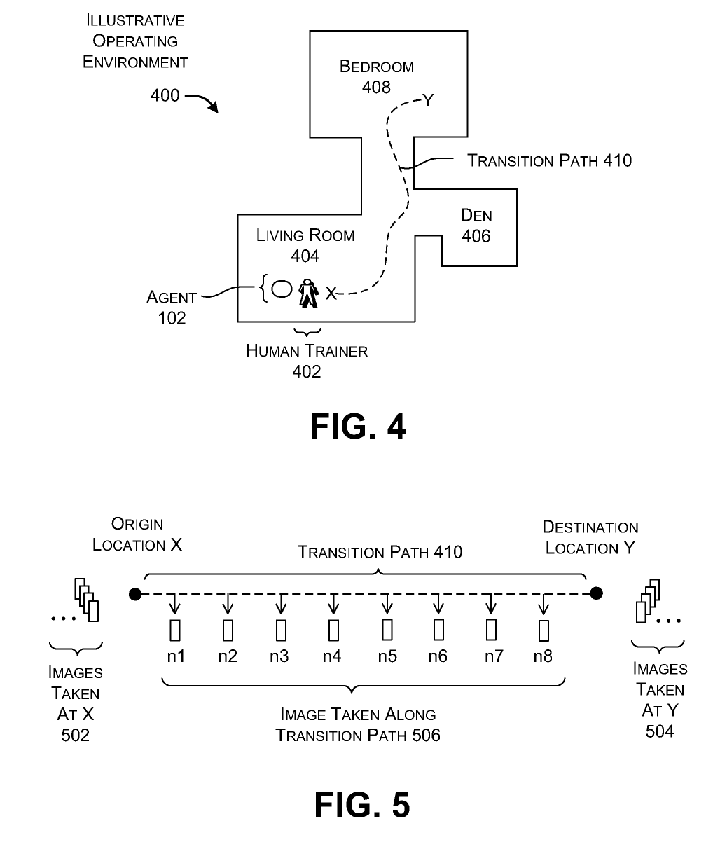

FIG. 4 shows an illustrative operating environment 400 in which the agent 100 can collect images using the human-agent interaction module 306, with the assistance of a human trainer 402. In this representative case, the environment 400 corresponds to a single-level apartment having a living room 404, a den 406, and a bedroom 408. This is a simplified scenario; the agent 100 can operate in environments of any degree of spatial scope and complexity.

The agent 100 in this scenario corresponds to a mobile robot of the type shown in FIG. 2. The agent 100 can include a radio frequency (RF) receiving device that detects a signal transmitted by an RF transmitting device carried by the human trainer 402. Using this coupling mechanism, the agent 100 can be configured to follow the human trainer 402 as he or she walks throughout the environment 400, e.g., by maintaining a prescribed distance behind the human trainer 402 as he or she walks. Further, the agent 100 can include a voice recognition system for detecting and responding to spoken commands and the like. These mechanisms are representative; other implementations can use different ways to guide the agent 100 through the environment 400. In another example, the human trainer 402 can manually pull or push the agent 100 through the environment 400. In another example, the human trainer can send instructions to the agent 100, e.g., via wireless communication, which cause it to move throughout the environment 400. In this scenario, the human trainer 402 can issue the commands from a location within the environment 400, or from a location that is remote with respect to the environment 400.

In the particular illustration of FIG. 4, the human trainer 402 is in the process of walking from location X to location Y along a transition path 410. The transition path 410 is arbitrary in the sense that there are no constraints as to how the human trainer 402 may advance from location X to location Y. The human trainer 402 may walk in any direction and make any variety of turns, including even a U-turn or about-face that leads the human trainer 402 back towards the origin location X. During this process, the agent 100 can be configured to take images at regular intervals of time.

In one approach, when the human trainer 402 reaches a node location, he or she can speak the name of that location. For example, upon reaching the living room 404, the human trainer 402 can speak the phrase “living room.” Upon receiving this information (using the voice recognition system), the agent 100 can be configured to organize all images taken at this location under a label of “living room.” Upon reaching the bedroom 408, the human trainer 402 speaks the word “bedroom.” This informs the agent 100 that it will now be collecting images associated with the bedroom 408. The agent 100 can associate any images taken in transit from the living room 404 to the bedroom 408 with the transition path 410, which it can implicitly label as “Living Room-to-Bedroom” or the like. Alternatively, the human trainer 402 can explicitly apply a label to the collection of images taken along the transition path 410 in the manner described above.

There are no constraints on how many node locations that the human trainer 402 may identify within the environment 400. And there are no constraints regarding what features of the environment that the human trainer 402 may identify as node locations. For example, the human trainer 402 can create multiple node locations within the living room 404, e.g., corresponding to different parts of the living room 404.

FIG. 5 shows the images captured by the agent 100 within the environment 400 described above. The images include a first collection of images 502 taken at location X, e.g., of the living room 404. The image include a second collection of images 504 taken at location Y, e.g., of the bedroom 408. Finally, the images include a third collection of images 506 taken along the transition path 410 leading from location X to location Y. The first collection of images 502 and the second collection of images 504 may organize their images in any order. The third collection of images 506 arranges its images according to an order in which these images were taken. This ordering can be represented by sequence numbers assigned to the images, e.g., n1, n2, etc. In one case, the sequence numbers may represent timestamps associated with the images at the time of their capture.

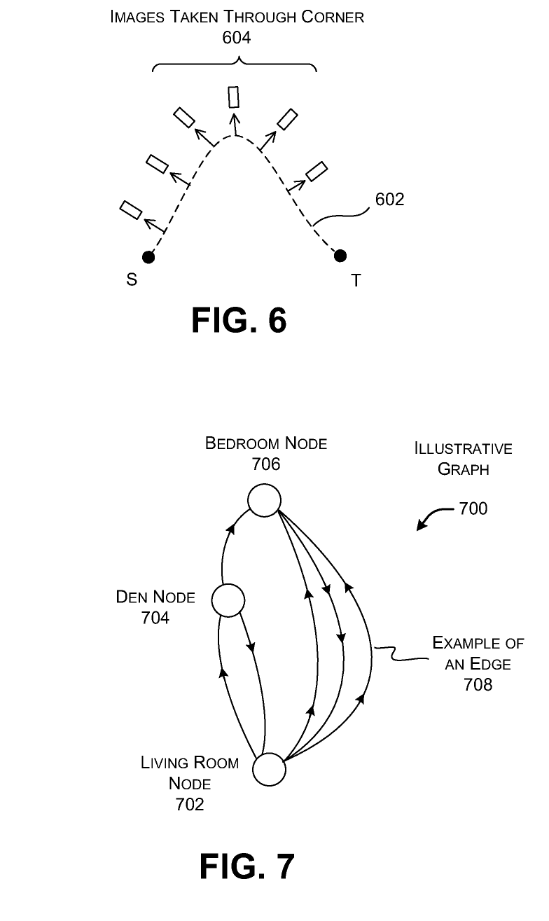

FIG. 6 shows a series of images taken at regular intervals over a transition path 602 that includes a relatively sharp turn. The agent 100 may reduce its speed as it navigates through this turn, e.g., due to the natural dynamics involved in making such turns. As a consequence, the agent 100 may take an increased number of images 604 over the course of the turn, compared, for example, to a straightaway portion of the transition path 602. This is due to the fact that the agent is 100 is capturing images at fixed intervals at but has slowed its rate of advancement over the course of the turn. This aspect of the image collection process is potentially advantageous because the additional images provide additional guidance to the agent 100 when it seeks to navigate through the turn in a real-time mode of operation. In other words, the additional images reduce the chances that the agent 100 will become “lost” when navigating through this region.

FIG. 7 shows a directed graph 700 created by the initial training module 104. The directed graph 700 includes a node 702 associated with the living room 404, a node 704 associated with the den 406, and a node 706 associated with the bedroom 408.

The directed graph 700 also includes a collection of edges that link together different nodes. For example, an edge 708 corresponds to the transition path 410 shown in FIG. 4. The edges are directed, meaning that they point from one node to another node associated with a direction of travel from one location to another location. The directed graph 700 can accommodate multiple edges between the same pair of nodes. For example, two edges connect the living room node 702 to the bedroom node 706. These two edges may correspond to two collections of images collected over two spatially distinct transition paths. Alternatively, or in addition, the two edges may reflect two collections of images obtained over the same transition path under different environmental conditions, such as different lighting conditions, or different floor surface conditions, or different clutter conditions, and so on. The agent 100 itself maintains an agnostic approach as to the underlying characteristics of transition paths associated with the edges. For example, an edge may have a certain cost associated therewith in a certain navigational context, but otherwise, the agent 100 may be unaware of or indifferent to the underlying fact that the edge may represent an idiosyncratic way of reaching a particular location. That is, the agent “sees” the edge as simply a sequence of images that lead from point X to point Y.

By way of terminology, the agent 100 is said to be related to a destination node via a single-hop path if the agent 100 can reach the destination node via a single edge. The agent 100 is said to be related to a destination node via a multi-hop path if the agent 100 can reach the destination node only via two or more edges in the directed graph 700.

As a final point with respect to FIG. 7, note that the directed graph 700 is a topological representation of the environment 400, rather than a metric-accurate representation of the environment 400. Hence, the directed graph 700 need not, and generally does not, represent the physical relationship of locations within the physical environment 400.

A.4. Illustrative High-Level Control Module

FIG. 8 shows the high-level (HL) control module 110 introduced in FIG. 1. By way of overview, the HL control module 110 determines actions to be taken by the agent 100. In the course of this task, the HL control module 110 also determines the probabilistic location of the agent 100.

The HL control module 110 includes (or can be conceptualized to include) a collection of component modules. To begin with, an observation determination module 802 receives one or more current input images from the sensing system 102 at a particular location. To simplify explanation, the following description assumes that the observation determination module 802 receives a single input image at a particular location, which captures the appearance or some other aspect of the environment at that location. The observation determination module 802 also interacts with graph images that were previously captured in the set-up phase (or at some later juncture as a result of the learning capabilities of the agent 100).

The observation determination module 802 generates observations. The observations reflect a level of initial confidence that the input image corresponds to different locations within the directed graph 700. In the following explanation, the term “location” is used liberally to represent both node locations (e.g., the living room node 702, the den node 704, and the bedroom node 706) and various edges that connect the node locations together. The observation determination 802 performs this task using the image matching module 114, e.g., by assessing the degree of similarity between the input image and graph images associated with different locations in the directed graph 700. As a result of this operation, the observation determination module 802 generates a list of the graph images which most closely match the input image. Because the graph images are associated with locations, this list implicitly identifies a list of possible graph locations that correspond to the input image.

However, the observations themselves are potentially noisy and may provide erroneous information regarding the location of the agent 100. To address this issue, the HL control module 110 uses a belief determination module 804 to generate probabilistic beliefs (“beliefs”) on the basis of the observations (provided by the observation determination module 802) and system dynamics, as expressed by high-level (HL) transition information 806. More specifically, the belief determination module 804 can use a Partially Observable Markov Decision Process (POMDP) to generate updated beliefs b^{t+1}(l) as follows:

$${b}^{t + 1} ( l ) = p ( O \vert l ) \cdot {\sum }_{M}^{all locs} p ( l \vert M , a ) \cdot {b}^{t} ( M ) . \qquad ( 1 )$$

In this equation, b^{t+1} (l) represents the belief that the agent 100 is located at location l at sampling instance t+1. p(O|l) represents the probability that an observation obtained by the observation determination module 802 can be attributed to the location l. In practice, p(O|l) may represent an image similarity score that assesses a degree of similarity between the current input image and the graph images associated with location l. b^{t}(M) represents a current belief associated with a location M, expressing the probability that the agent 100 is associated with that location M. That is, the current belief b^{t}(M) represents a belief that was calculated using Equation (1) in a previous sampling instance. p(l|M, a) represents a probability (referred to as a transition probability) that the agent 100 will be found at location l given a location M and an action a that is being performed by the agent 100. Equation (1) indicates that the product p(l|M,a)·b^{t}(M) is summed over all locations M in the directed graph 700. Finally, the belief determination module 804 performs the computation represented by Equation (1) with respect to all locations l in the directed graph 700.

Less formally stated, Equation (1) weights the probability p(O|l) by the current system dynamics, represented by the sum in Equation (1). The system dynamics has the effect of de-emphasizing location candidates that are unlikely or impossible in view of the current operation of the agent. Hence, the system dynamics, represented by the sum in Equation (1), is also referred to as a filtering factor herein. The outcome of the operation of the belief determination module 804 is a set of beliefs (e.g., updated beliefs) for different locations l in the directed graph 700. These beliefs reflect the likelihood that the agent 100 is associated with these different locations l.

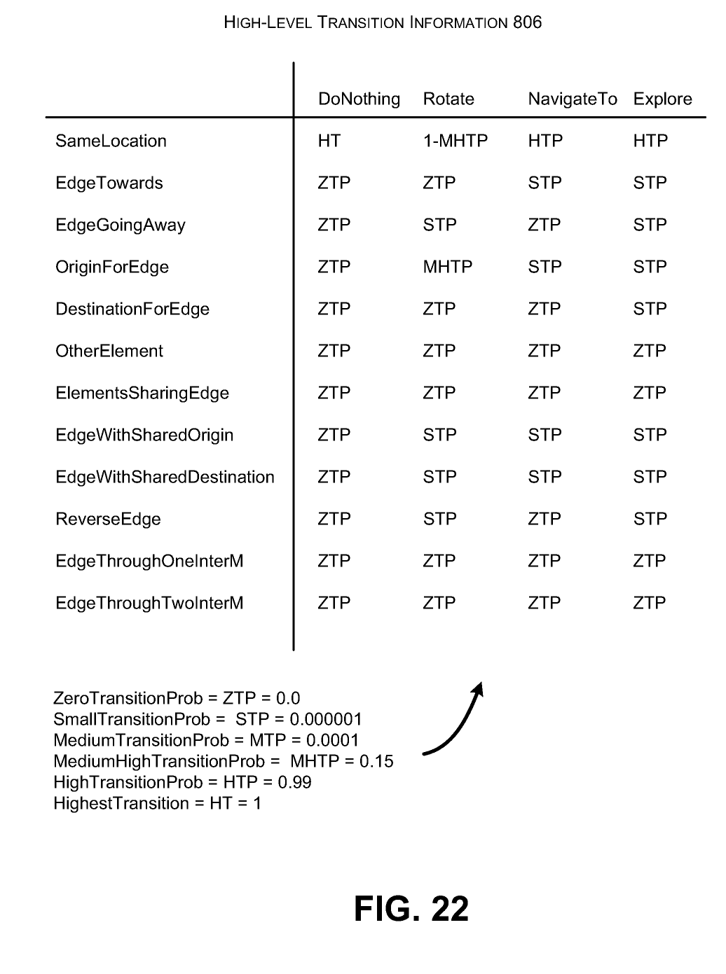

The transition probabilities p(l|M, a) defined by different combinations of l, M, and a are collectively referred to as the HL transition information 806. As shown in FIG. 9, the HL transition information 806 can be expressed as a table. One axis of the table identifies different relations of location M to location l; hence, the system dynamics implicitly takes into consideration the structure of the environment. Another axis of the table identifies different actions that the agent 100 can perform (e.g., “do nothing,” rotate, navigate, and explore). The body of the table identifies different translation probabilities associated with different combinations of relations and actions. FIG. 22, to be discussed in greater detail below, shows one representative implementation of such a translation table.

Returning to FIG. 8, a vote determination module 808 identifies different actions to be taken from the “perspective” of the different locations l in the directed graph 700. In other words, each location l can be viewed as an actor which assumes that the agent 100 is located at its location l. Based on this assumption, each location l recommends an action that is most appropriate to advance the agent 100 from the location l to a destination location that the agent 100 is attempting to achieve. In one representative implementation, possible actions include “do nothing” (in which the agent 100 takes no action), rotate (in which the agent 100 rotates in attempt to find an edge), navigate (in which the agent 100 navigates along an edge), and explore (in which the agent 100 “wanders” through the environment with no goal other than to find open space and avoid obstacles).

Thus, for example, node locations in the directed graph 700 (e.g., the living room node 702) will vote for either do nothing or rotate. More specifically, a node location will vote for “do nothing” if it corresponds to the destination node (since the agent 100 has already reached its destination and no action is needed). A node location will vote for rotate if does not correspond to the destination node (since it is appropriate for the agent 100 to find an edge over which it may reach the destination node). Node locations do not vote for navigate or explore because, in one implementation, edges are the only vehicles through which the agent 100 moves through the directed graph 700.

An edge location will vote for navigate, rotate, or explore. Section B will provide further details on the circumstances in which each of these votes is invoked. By way of overview, an edge location may vote for navigate if advancement along the edge is considered the most effective way to reach the destination location—which would be the case, for instance, if the edge directly leads to the destination location. An edge location may vote for rotate if advancement along the edge is not considered the most effective way to reach the destination location. An edge location may vote for explore if it is determined that the agent is operating within a stuck state (to be described below), meaning that it is not making expected progress towards a destination location.

In certain cases, an edge location may represent an edge that is directly connected to a destination location. In another case, an edge location may represent an edge that is indirectly connected to the destination location through one or more additional edges. To address this situation, an edge location may vote for a particular action based on an analysis of different ways of advancing through the directed graph to achieve a destination location. To facilitate this task, the vote determination module 808 can rely on any graph analysis tool, such as the Floyd-Warshall algorithm. These types of tools can identify different paths through a directed graph and the costs associated with the different paths. In the present context, the cost may reflect an amount of time that is required to traverse different routes. There is also a cost associated with the act of rotation itself. Costs can be pre-calculated in advance of a navigation operation or computed during a navigation operation.

The vote determination module 808 weights each vote by the beliefs provided by the belief determination module 804. The weighted votes reflect the appropriateness of the votes. Thus, for example, a particular location may vote for rotate. However, assume that this location is assigned a very small belief value that indicates that it is unlikely that the agent 100 is associated with that location. Hence, this small belief value diminishes the appropriateness of the rotate action.

A vote selection module 810 selects one of the votes associated with one of the locations. The vote selection module 810 may select the vote having the highest associated belief value. In certain cases, the vote selection module is asked to consider votes which reflect different possible paths to reach a destination location, including possible multi-hop routes that have multiple edges. In these cases, the vote selection module 810 can also consider the cost of using different routes. Cost information can be provided in the manner described above.

An action execution module 812 generates commands which carry out whatever action has been selected by the vote selection module 810.

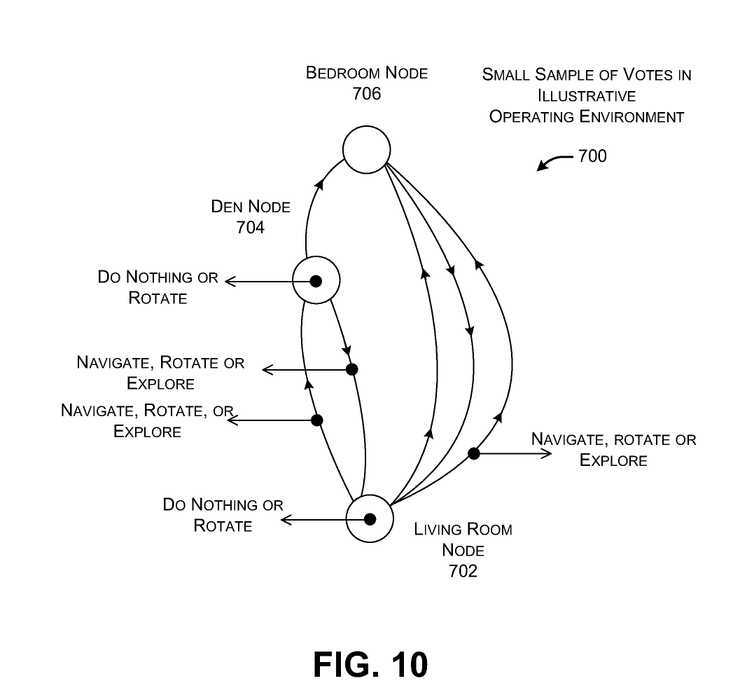

FIG. 10 presents a graphical depiction of the some of the concepts described above in the context of the illustrative directed graph 700. As shown there, the node locations (702, 704, 706) vote for either “do nothing” or rotate. The edge locations vote for navigate, rotate, or explore.

A.5. Illustrative Low-Level Control Module

FIG. 11 shows the low-level (LL) control module 112 introduced in FIG. 1. The LL control module 112 is specifically invoked when the HL control module 110 selects a vote of navigate. The LL control module 112 then performs a series of tasks which implement the navigation of the agent 100 along a selected edge.

As a preliminary issue, the HL control module 110 may select a vote of navigate, but it remains a question of what edge is to be called upon to perform the navigation. In one case, the HL control module 110 selects the edge having the highest vote score. That vote score may be based on the belief that has been determined for that particular edge location l. That vote score may also reflect a determination of a cost associated with using that edge to reach the destination location.

As to the LL control module 112, an observation determination module 1102 performs an analogous function to the observation determination module 802 of the HL control module 110. Namely, the observation determination module 1102 receives the current input image and provides access to a collection of graph images in the directed graph. Here, however, the observation determination module 802 specifically interacts with a collection of graph images associated with the selected edge to be traversed by the agent 100. The observation determination module 1102 then, with the assistance of the image matching module 114, generates observations which reflect the extent of similarity between the input image and the graph images along the edge.

A belief determination module 1104 performs an analogous function to the belief determination module 804 of the HL control module 110. Namely, the belief determination module 1104 generates updated beliefs which identify the probability that the input image corresponds to one of the images along the edge. Here, however, the POMDP approach is based on a consideration of images i, rather than locations l.

$${b}^{t + 1} ( i ) = p ( O \vert i ) \cdot {\sum }_{M}^{all locs over edge} p ( i \vert M , a ) \cdot {b}^{t} ( M ) . \qquad ( 2 )$$

That is, b^{t+1}(i) reflects the assessed likelihood that the input image corresponds to image i along an edge. b^{t}(M) again refers to the previously calculated belief (from a prior sample interval). p(i|M, a) refers to the transition probability that the agent 100 correspond to image i given the assumption that the agent 100 is performing action a with respect to image M. In this case, the action a corresponds to the speed of advancement of the agent 100 along the edge. Collectively, the transition probabilities for p(i|M, a) correspond to low-level (LL) transition information 1106. The sum of the p(i|M, a)·b^{t}(M) over all locations in the edge can be referred to as a filtering factor because it has the effect of discounting possibilities in view of the prevailing movement of the agent 100. In other words, the filtering factor again takes the system dynamics into account to improve its probabilistic analysis of the location of the agent 100.

FIG. 12 plots the beliefs generated by the belief determination module 1104. The series of beliefs establishes a probability distribution over the edge. A peak of the distribution may correspond to the image along the edge that is most likely to be associated with the location of the agent 100. Recall that images along the edge are arranged in a predetermined order and are annotated with some kind of sequence number or index, such as a timestamp. In the present case, image n4 corresponds to the image having the highest belief.

Returning to FIG. 11, a location determination module 1108 provides further insight into the probable location of the agent 100 along the edge. One way that the location determination module 1108 can perform this function is by identifying the image along the edge that has the highest belief value (which is n4 in the example of FIG. 12). The location determination module 1108 can then divide the sequence number of this image (n4) by the total number of images on the edge (which is 8 in the case of FIG. 12). This ratio provides some indication of the physical location of the agent 100 on a transition path between one location in the environment 400 and another location.

The LN module 108 can use the results of the location determination module 1108 for different purposes. In one case, the LN module 108 can use the results to determine when the agent 100 has arrived at its destination location. In one case, the LN module 108 can determine that the agent 100 has arrived at its destination location when it reaches the last Z % of the transition path, such as 5%. The LN module 108 can also use the results of the location determination module 1108 to calculate the costs of various action options, such as navigate, rotate, etc.

An offset determination module 1110 determines an offset between the current input image and the images along the edge. It then passes this offset to the control system 118. The control system 118 uses this value to control the movement of the agent 100 along the edge.

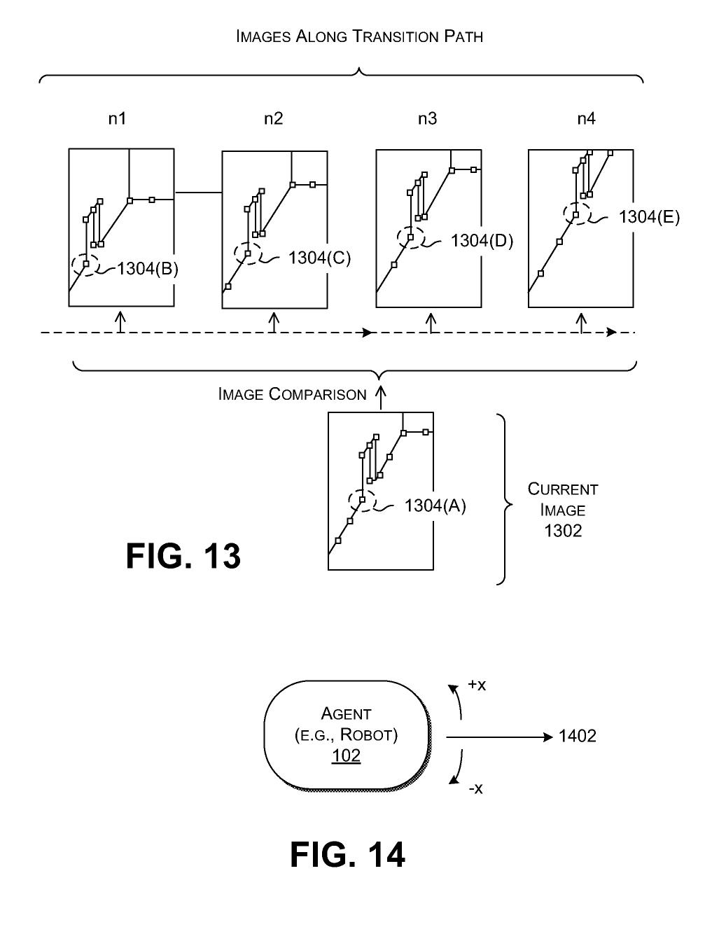

To illustrate the operation of the offset determination module 1110, consider the scenario shown in FIG. 13. Here, there are at least four graph mages (n1, n2, n3, and n4) along the edge. The current input image corresponds to input image 1302. Each of the images in FIG. 2 can be characterized by a set of distinguishing features. For example, the input image 1302 includes a feature 1304(A) corresponding to a corner or other edge in the image. The graph images (n1, n2, n3, and n4) resemble the input image 1302, and therefore also include this distinguishing feature. That is, graph image n1 includes corresponding feature 1304(B), graph image n2 includes corresponding feature 1304(C), graph image n3 includes corresponding feature 1304(D), and graph image n4 includes corresponding feature 1304(E), and so on.

The offset determination module 1110 computes the offset by considering the displacement of one or more features in the input image 1302 from one or more features in one or more graphs images. In the context of FIG. 13, this means that the offset determination module 1110 computes the offset of feature 1304(A) from one or more counterpart features (B, C, D, and E) in the graph images. This process can be repeated for all the features in the images. More formally stated, the offset ζ can be computed by:

$$\overline{Ϛ} = {\sum }_{k}^{all features} {\sum }_{i}^{all images in edge} ( {x}_{ik} - {f}_{zk} ) \cdot b ( i ) . \qquad ( 3 )$$

Here, the index i refers to a graph image in the edge, z refers to the input image, k refers to a common feature in the figures, xᵢₖ refers to a position of the feature k in the graph image i, f_{zk} refers to a position of the feature k in input image z, and b(i) refers to the current belief value assigned to image i. The term (xᵢₖ−f_{zk}). b(i) is summed over different images i and different features k to generate the final offset ζ. Less formally stated, Equation (3) can be said to compute the offset in a probabilistic manner by based on the variable contribution of different images to the offset. If there is only a small probability that an input image corresponds to a particular image along the edge, then the weighting factor b(i) will appropriately diminish its influence in the determination of the final offset value.

Simplified versions of Equation (3) can also be used. Instead of taking into consideration all the graph images along the edge, the offset determination module 1110 can determine the final offset based on a comparison of the input image with just the best-matching graph image associated with the edge, or with just a subset of best-matching graph images, as optionally weighted by the beliefs associated those matching graph images.

As stated, the control system 118 controls the movement of the agent 100 along the edge based on the offset. Note, for instance, FIG. 14, in which the agent 100 seeks to move along a transition path 1402. The offset can control a power-left and power-right control that is applied to the motor(s) of the agent 100, causing the agent 100 to move in the illustrated +x direction or the −x direction.

The control system 118 can use a controller of any type to control the motor(s) of the agent 100, based on the offset. For example, the control system 118 can use a PID (proportional-integral-derivative) controller or a PI (proportional-integral) controller that uses a closed-loop approach to attempt to minimize an error between the offset and the current position of the agent 100.

A.6. Illustrative Graph Updating Module

FIG. 15 shows the graph updating module 120 introduced in FIG. 1. Recall that the purpose of this module is to update the directed graph in various ways or update the configuration information used to govern the operation of the LN module 108.

The graph updating module 120 can include (or can be conceptualized to include) an ongoing training module 1502. As the name suggests, the purpose of the ongoing training module 1502 is to modify the directed graph or the configuration information as a result of navigation that is performed by the agent 100 within the environment 400 in a real-time mode of operation.

In one example, the ongoing training module 1502 adds a new edge to the directed graph when the agent 100 successfully navigates from one node location to another node location. In another example, the ongoing training module 1502 adjusts the HL transition information 806 and/or the LL transition information 1106 on the basis of navigation performed within the environment 400. In another example, the ongoing training module 1502 adjusts any other configuration information as a result of navigation performed within the environment. It is also possible to make other corrective modifications upon performing navigation that is deemed unsuccessful.

Further, the agent 100 can be placed in an explore mode in which it essentially wanders through the environment in an unsupervised manner, capturing images in the process. The ongoing training module 1502 can supplement its information regarding node locations based on images captured in this process. The ongoing training module 1502 can also add new edges based on images captured in this process.

A graph modification module 1504 performs any kind of maintenance on the graph at any time. For example, the graph modification module 1504 can perform analysis that identifies similar images associated with the directed graph. Based on this analysis, the graph modification module 1504 can prune (remove) one or more edges that are determined to be redundant with one or more other edges.

Alternatively, or in addition, the graph modification module 1504 can add new juncture points to edges to improve the performance of the agent 100. Consider the case of FIG. 16, which illustrates two edges. A first edge links node location A and node location B, while a second edge links node location A and node location C. Assume further that these two edges represent transition paths that follow the same course up to some point, but then diverge towards different destinations (B and C, respectively). The graph modification module 1504 can address this situation by adding a juncture point J 1602 at the point where the edges diverge. This partitions the directed graph, creating four edges, two edges segments from A to J, a third edge segment from J to B, and a fourth edge segment from J to C.

Adding the new juncture point J 1602 may advantageously reduce conflicting votes among edge locations. Say, for example, that the destination node is node B. The edge from A to B is the actor which is expected to generate the desired vote of navigate. However, the edge from A to C presumably has similar images to the edge from A to B over the initial span in which they generally coincide. As such, the edge from A to C may generate relatively high probabilistic beliefs when the agent 100 is “near” node A, which may result in strong votes for an inappropriate action, such as rotate. By adding the juncture point J 1602, the two edges which connect locations A and J will not generate conflicting votes.

FIG. 15 also shows an optional remote service 1506, which may correspond to a computing system that is local with respect to the environment or remote with respect to the environment. In the latter case, the remote service 1506 can be coupled to the agent 100 via a network of any type, such as a wide area network (e.g., the Internet).

The remote service 1506 can store any type of image information, graph information, and/or configuration information. Such storage can supplement the local storage of information in store 106 or replace the local storage of information in store 106. In addition, or alternatively, the remote service 1506 can perform any of the graph-related updating tasks. Such update-related processing can supplement the processing performed by the graph updating module 120 or replace the processing performed by the graph updating module 120. In one case, the remote service 1506 can download the results of its analysis to the agent 100 for its use in the real-time mode of operation. In yet another implementation, the agent 100 can consult any information maintained in the remote service 1506 during the real-time mode of operation.

B. Illustrative Processes

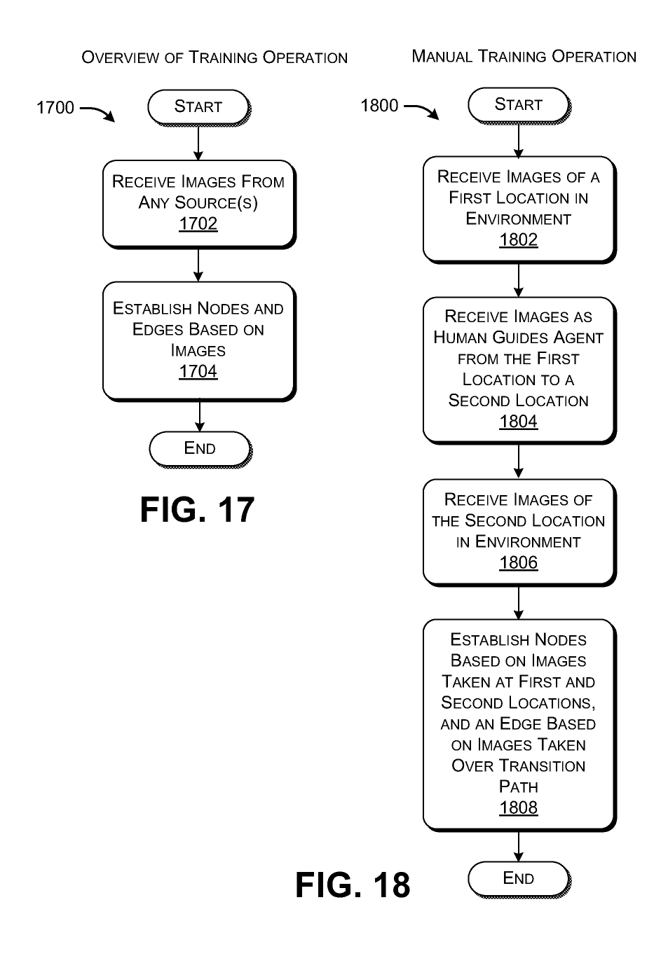

FIGS. 17-29 show procedures that set forth the illustrative operation of the agent 100 in flowchart form. Since the principles underlying the operation of the agent 100 have already been described in Section A, many of the operations will be addressed in summary fashion in this section.

B.1. Illustrative Training Operation

FIG. 17 shows an illustrative procedure 1700 that presents an overview of a training operation performed by the agent 100 of FIG. 1.

In block 1702, the agent 100 receives any type of images from any source in any manner.

In block 1704, the agent 100 establishes the directed graph based on the images and labels associated therewith. The graph can include constituent nodes and edges.

FIG. 18 shows an illustrative procedure 1800 that describes a manual manner of training the agent 100 of FIG. 1.

In block 1802, the agent 100 is guided to a first location in an environment by a human trainer. At that point, the agent 100 receives images of the first location.

In block 1804, the agent 100 receives images as the human trainer guides the agent 100 from the first location to a second location.

In block 1806, the agent 100 receives images of the second location.

In block 1808, the agent 100 establishes a first node based on the set of images captured at the first location and a second node based on the set of images captured at the second location. The agent 100 also establishes an edge based on the images taken in transit from the first location to the second location.

In one case, there is no sharp demarcation between the three sets of images described above. For instance, the first set of images and the second set of images may share a subset of images with the edge-related images.

B.2. Illustrative High-Level Controlling Operation

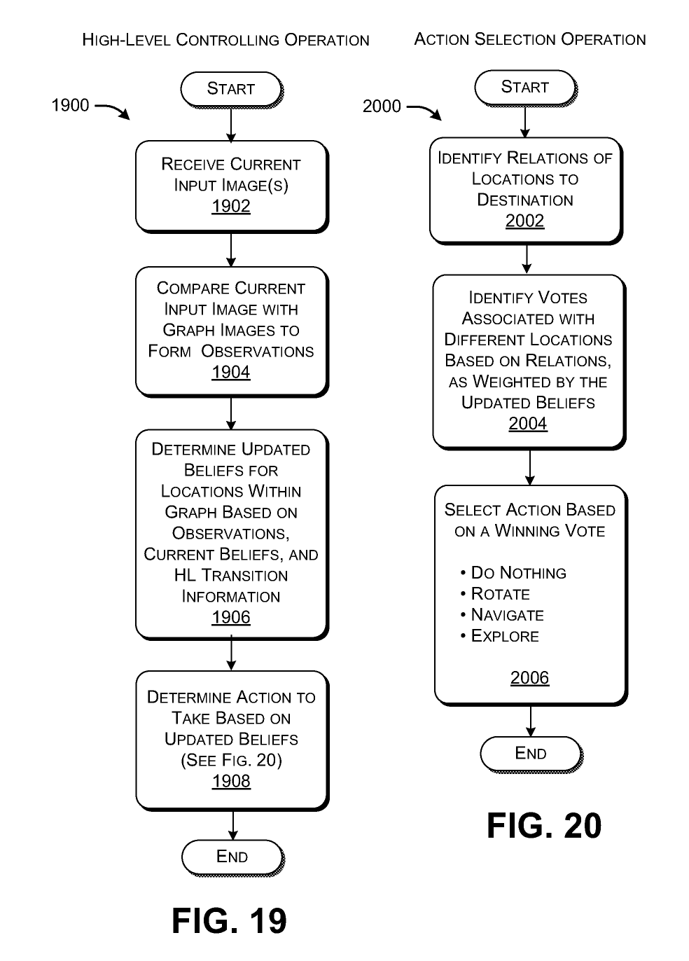

FIG. 19 shows an illustrative procedure 1900 that describes a high-level controlling operation performed by the agent 100 of FIG. 1.

In block 1902, the agent 100 receives one or more current input images based on its current position within the environment. To simplify the description, the high-level controlling operation will be explained in the context of the receipt of a single input image.

In block 1904, the agent 100 compares the current input image with graph images to provide a series of observations associated with different locations in the directed graph.

In block 1906, the agent 100 determines updated beliefs based on Equation (1) described above. As previously explained, the updated beliefs are based on observations, current beliefs, and the HL transition information 806.

In block 1908, the agent 100 determines an action to take based on the updated beliefs.

FIG. 20 shows an illustrative procedure 2000 that provides additional details regarding one way to select an action.

In block 2002, the agent 100 identifies, for each location in the directed graph, the relation of this location to a destination location.

In block 2004, the agent 100 identifies votes associated with different locations in the directed graph. As discussed in Section A, the agent 100 can generate these votes based on the relations determined in block 2002. The agent 100 weights the votes by the updated beliefs. The agent 100 can also take into account costs associated with traversing different routes to achieve the destination location.

In block 2006, the agent selects the vote with the high score. The selected action may correspond to “do nothing,” rotate, navigate, or explore.

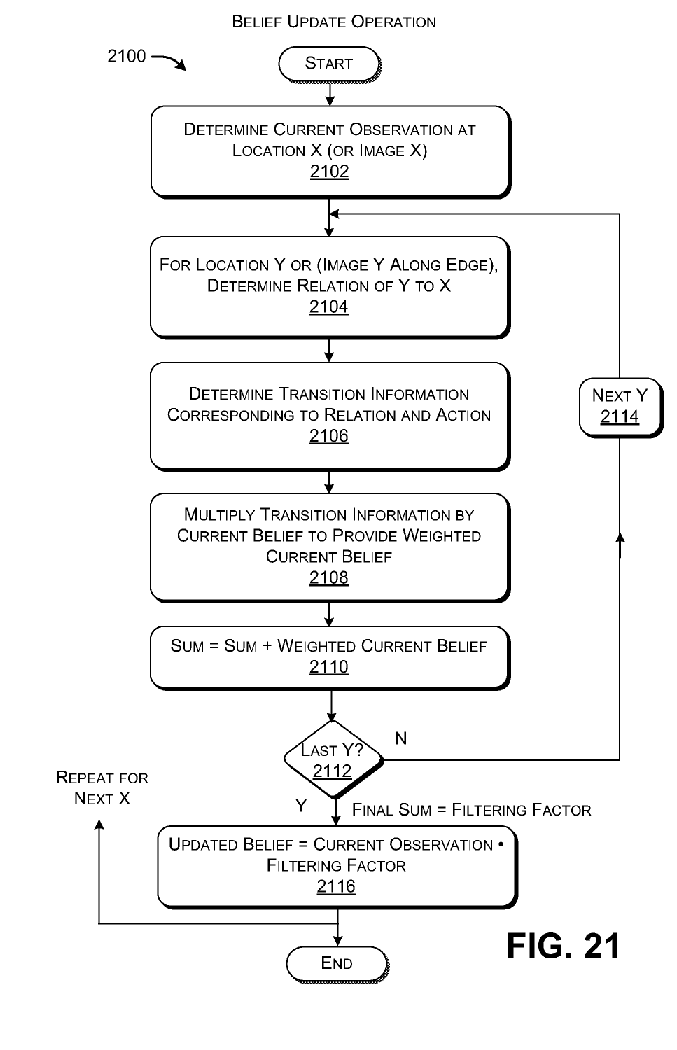

FIG. 21 shows an illustrative procedure 2100 that describes a belief update operation that can be performed by the agent of FIG. 1. This belief update operation can be performed by the HL control module 110 (in the context of locations) or by the LL control module 112 (in the context of images). In other words, the procedure 2100 expresses both Equations (1) and (2) in flowchart form. To simplify the explanation, the procedure 2100 will be described here in the first scenario, e.g., in the context of processing performed by the HL control module 110.

In block 2102, the agent 100 determines a current observation at a location X, based on image-matching analysis performed with respect to the input image.

In block 2104, the agent 100 begins an inner summation loop by determining a relation of a location Y to the location X.

In block 2106, the agent 100 looks up a transition probability within the HL transition information 806 associated with the relation identified in block 2104 and an action being taken by the agent 100.

In block 2108, the agent 100 multiples the transition probability provided in block 2106 by the current belief associated with location X.

In block 2110, the agent 100 updates the sum based on the result of block 2108.

In block 2112, the agent 100 determines whether the last location Y has been processed. If not, in block 2114, the agent 100 advances to the next location Y and repeats the above-identified operations for the new location Y. Upon processing the last location Y, the agent 100 will have generated the sum identified in Equation (1), referred to as a filtering factor herein.

In block 2116, the agent 100 multiplies the filtering factor by the current observation provided in block 2102. This provides the updated belief for location X. FIG. 21 indicates that the entire procedure described above can then be repeated for another X within the directed graph.

The HL transition information 806 used within the procedure 2100 can be implemented as a table which provides relations between Y and X on a first axis, and different actions on another axis. The body of the table provides different transition probabilities associated with different combinations of relations and actions.

FIG. 22 shows one representative translation table. In this example, “SameLocation” refers to a relation in which Y is the same location as X. “EdgeTowards” refers to a relation in which Y is an edge that leads towards X. In “EdgeGoingAway,” Y is an edge that goes away from X. In “OriginForEdge,” Y is a location that is the starting point for edge X. In “DestinationForEdge,” Y is a location that is the end point (destination) for edge X. In “OtherElement,” Y is a location different than X. In “ElementsSharingEdge,” Y is a location that is connected through a single edge, to location X. In “EdgeWithSharedOrigin,” Y is an edge that shares an origin location with edge X. In “EdgeWithSharedDestination,” Y is an edge that shares a destination location with edge X. In “ReverseEdge,” Y is the reverse edge to edge X (goes from location B to A and X goes from A to B). In “EdgeThroughOneInterM,” Y is an edge that has a single intermediary location between it and edge X. In “EdgeThroughTwoInterM,” Y is an edge that has two or more intermediary locations between it and edge X.

The particular transition probabilities identified in the translation table are illustrative and non-limiting. Further, in one implementation, the agent 100 can modify the values of these transition probabilities based on the navigation performance of the agent 100.

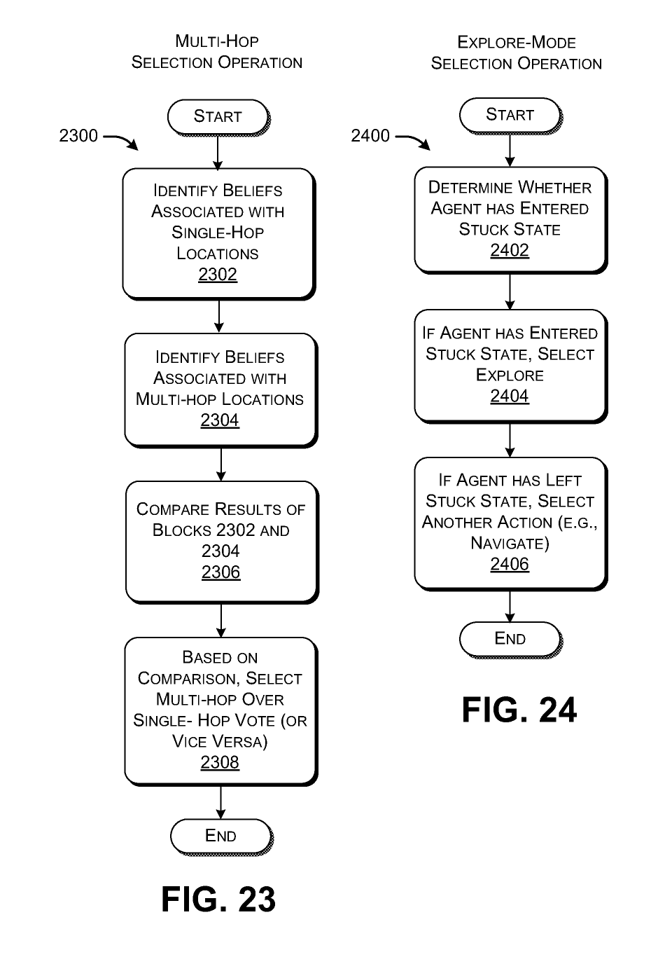

FIG. 23 shows an illustrative procedure 2300 that describes a multi-hop selection operation. This is a specific operation encompassed by the high-level control operation of FIGS. 19 and 20. As described above, a multi-hop route between two nodes encompasses two or more edges. A single-hop route involves a single edge.

In block 2302, the agent 100 identifies beliefs and/or costs associated with single-hop locations. The single-hop locations correspond to locations that will direct the agent 100 to a destination node using a single edge.

In block 2302, the agent 100 identifies beliefs and/or costs associated with multi-hop locations. The multi-hop locations correspond to locations that will direct the agent 100 to the destination node using two or more edges.

In block 2306, the agent 100 can perform any type of comparative analysis which takes account for the results of block 2302 and 2304. In one case, the agent 100 can sum the beliefs associated with the single-hop locations to generate a first sum, and sum the beliefs associated with the multi-hop locations to generate a second sum. Then, the agent 100 can compare the first sum with the second sum.

In block 2308, the agent 100 can select a multi-hop route over a single-hop route, or vice versa, based on the analysis provided in block 2306. For example, suppose that the sum of the multi-hop beliefs is considerably larger than the sum of the single-hop beliefs. This suggests that it will probably be more fruitful to select a multi-hop route over a single-hop route. But if the sum of the multi-hop beliefs is not significantly larger (e.g., at least 100 times larger) than the sum of the single-hop beliefs, then the agent 100 may decide to ignore the multi-hop beliefs. This summing and thresholding operation is useful to stabilize the performance of the voting between multi-hop options and single-hop options. Without this provision, there may be an undesirable amount of noisy flip-flopping between multi-hop options and single-hop options (e.g., because different options may have very similar vote scores). In other words, the summing and thresholding option make it more likely that when a multi-hop option is invoked, it is truly the appropriate course of action.

FIG. 24 shows an illustrative procedure 2400 that describes an explore-mode selection operation, which is another specific operation encompassed by the high-level controlling operation of FIGS. 19 and 20.

In block 2402, the agent 100 determines whether it has entered a stuck state. The stuck state is characterized by a state in which the agent 100 is not making progress toward a destination location. The agent 100 can determine that this state has been reached based on any combination of context-specific criteria. In one case, the agent 100 can determine that the stuck state has been reached based on an amount of time that has transpired in attempting to reach the destination location (in relation to normal expectations). In addition, or alternatively, the agent 100 can determine that the stuck state has been reach based on the number of options that have been investigated in attempting to reach the destination location.

In block 2404, if in a stuck state, the agent 100 enters an explore mode of operation. In the explore mode, the agent 100 uses depth information and/or visual information to move towards what it perceives as the largest open space available to it. The agent 100 will attempt to avoid obstacles in this mode, but otherwise has no overarching goals governing its navigational behavior. The agent 100 is simply attempting to wander into a region which will present a different set of navigational opportunities, associated with a different set of probabilistic beliefs.

In block 2406, the agent 100 determines that it is no longer in the stuck state, upon which it abandons the explore mode and selects another action. The agent 100 can determine that it is no longer in the stuck state based on any combination of factors, such as the amount of time spent in the explore mode, the updated beliefs associated with locations, and so on.

In one implementation, the agent 100 can determine whether it is in a stuck state or in a progress state using the same probabilistic approach described above. Here, the stuck state and progress state correspond to two of the possible states that characterize the operation of the agent 100.

B.3. Illustrative Low-Level Controlling Operation

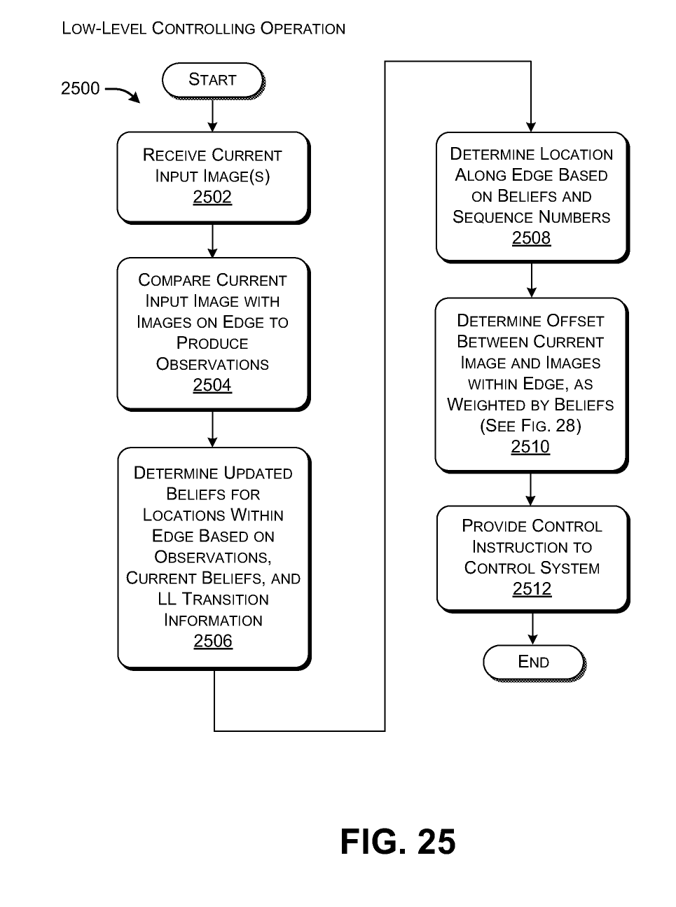

FIG. 25 shows an illustrative procedure 2500 that describes a low-level controlling operation performed by the agent 100 of FIG. 1. Recall that, in this procedure 2400, the LL control module 112 attempts to advance the agent 100 along a selected edge.

In block 2502, the agent 100 receives a current image.

In block 2504, the agent compares the current image with graph images associated with the edge to generate observations.

In block 2506, the agent 100 uses Equation (2) to determine updated beliefs. These updated beliefs take account of the observations provided in block 2504, the LL transition information 1106, and the current beliefs.

In block 2508, the agent 100 uses the updated beliefs to determine its probable location along the edge. The agent 100 can perform this operation by determining the sequence number associated with an image on the edge having the highest belief value, and dividing this sequence number by the total number of images on the edge.

In block 2510, the agent 100 uses Equation (3) to determine the offset between the input image and the images on the edge, as weighted by the belief provided in block 2506.

In block 2512, the agent 100 uses the offset to provide control instructions to the control system 118 of the agent 100, causing the agent 100 to move in the manner shown in FIG. 14.

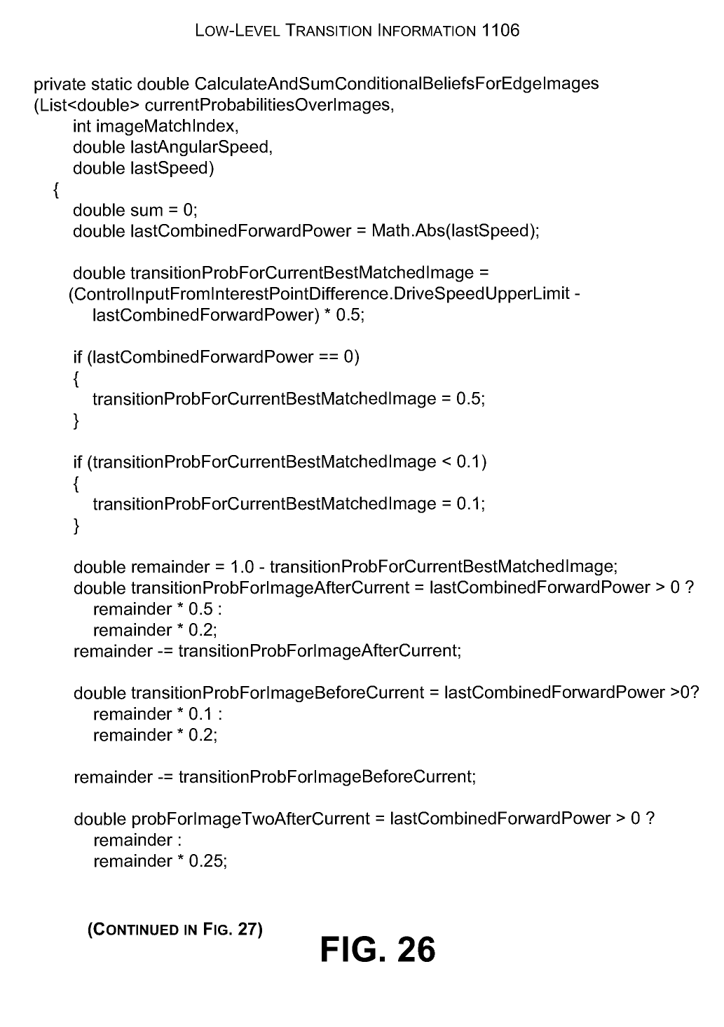

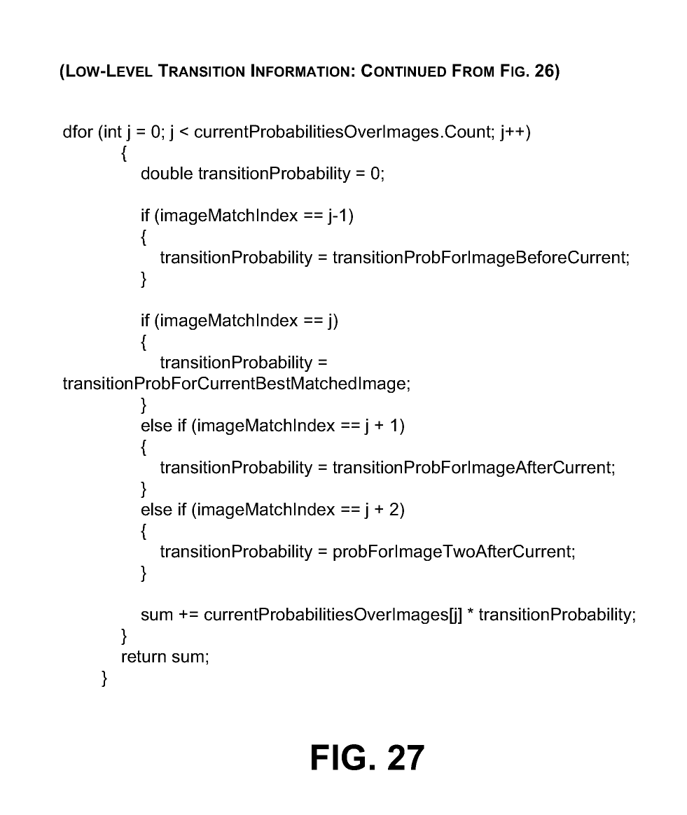

FIGS. 26 and 27 together show an illustrative algorithm for providing the LL transition information 1106 used by the procedure of FIG. 25. In this case, the agent 100 computes appropriate transition probabilities based, in part, on the speed of the agent 100. That is, if the agent 100 is not moving, then the beliefs correspond to the image-matching observations themselves. For a non-zero speed, the belief for any image on the edge takes into account the probabilities of other images on the edge.

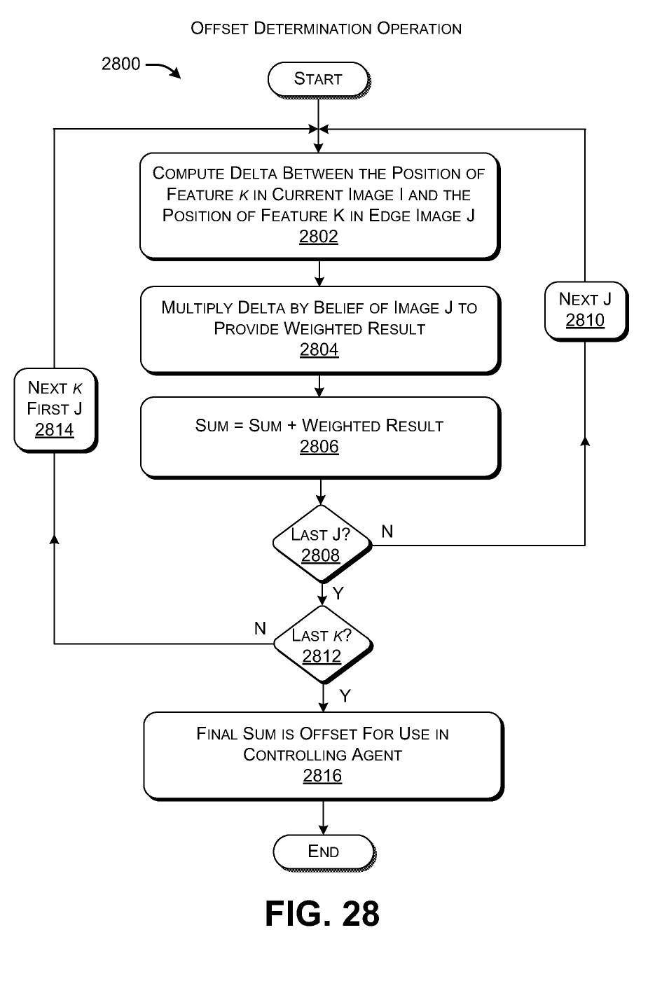

FIG. 28 shows an illustrative procedure 2800 that describes an offset determination operation. This procedure 2800 graphically represents the operations performed by Equation (3).

In block 2802, the agent 100 computes the difference between the position of feature k in an image I associated with the current input image and the position of feature k in an edge image J.

In block 2804, the agent 100 multiples the difference computed in block 2502 by the belief associated with image J.

In blocks 2806, 2808, 2810, 2812, and 2814, the agent 100 optionally repeats the above-described process for different images J and different features k.

In block 2816, the agent 100 provides a final offset, associated with a sum computed in the proceeding blocks. The agent 100 can use the offset to control the movement of the agent 100 so that it conforms to the transition path associated with the edge.

B.4. Illustrative Graph Updating Operation

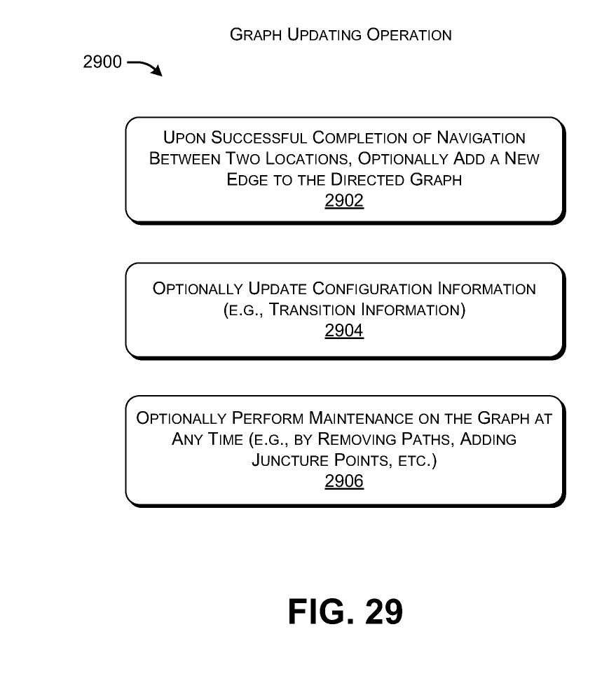

FIG. 29 shows an illustrative procedure 2900 that describes a graph updating operation performed by the agent of FIG. 1. The blocks in the procedure 2900 represent functions that can be performed separately or together; as such, FIG. 29 does not show connections between these bocks.

In block 2902, the agent 100 optionally adds a new edge to the directed graph upon a successful navigation operation.

In block 2904, the agent 100 optionally updates any type of configuration information in response to a navigation operation. For example, the agent 100 can update the transition information used by the HL control module 110 and/or the LL control module 112.

In block 2906, the agent 100 optionally performs any type of maintenance on the graph at any time. For example, the agent 100 can remove redundant edges, add new junction points, and so on.

C. Representative Processing Functionality

FIG. 30 sets forth illustrative electrical data processing functionality 3000 that can be used to implement any aspect of the functions described above. With reference to FIG. 1, for instance, the type of processing functionality 3000 shown in FIG. 30 can be used to implement any aspect of the agent 100. In one case, the processing functionality 3000 may correspond to any type of computing device that includes one or more processing devices.

The processing functionality 3000 can include volatile and non-volatile memory, such as RAM 3002 and ROM 3004, as well as various media devices 3006, such as a hard disk module, an optical disk module, and so forth. The processing functionality 3000 also includes one or more general-purpose processing devices 3008, as well as one or more special-purpose processing devices, such as one or more graphical processing units (GPUs) 3010. The processing functionality 3000 can perform various operations identified above when the processing devices (3008, 3010) execute instructions that are maintained by memory (e.g., RAM 3002, ROM 3004, or elsewhere). More generally, instructions and other information can be stored on any computer readable medium 3012, including, but not limited to, static memory storage devices, magnetic storage devices, optical storage devices, and so on. The term computer readable medium also encompasses plural storage devices. The term computer readable medium also encompasses signals transmitted from a first location to a second location, e.g., via wire, cable, wireless transmission, etc.

The processing functionality 3000 also includes an input/output module 3014 for receiving various inputs from an environment (and/or from a user) via input modules 3016 (such as one or more sensors associated with the sensing system 102 of FIG. 1). The input/output module 3014 also provides various outputs to the user via output modules. One particular output mechanism may include a presentation module 3018 and an associated graphical user interface (GUI) 3020. The processing functionality 3000 can also include one or more network interfaces 3022 for exchanging data with other devices via one or more communication conduits 3024. One or more communication buses 3026 communicatively couple the above-described components together.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A location and navigation module implemented by electrical data processing functionality, comprising:
a high-level control module configured to determine an action to be taken by an agent within an environment based, in part, on structure of the environment, the high-level control module comprising:
a belief determination module configured to determine a plurality of probabilistic beliefs that identify an extent to which the agent is associated with different respective locations of a directed graph;
a vote determination module configured to generate a plurality of votes associated with the different respective locations, each vote identifying an action to be taken by the agent, the plurality of votes being weighted, respectively, by the plurality of probabilistic beliefs; and
a vote selection module configured to select one of the plurality votes and an associated action based on the plurality of probabilistic beliefs; and
a low-level control module configured to implement a navigation action selected by the high-level control module based, in part, on motion of the agent within the environment, the navigation action advancing the agent along an identified edge in the directed graph.

2. The location and navigation module of claim 1, wherein other actions that can be selected correspond to:
an idle action in which the agent takes no action;
a rotate action in which the agent rotates; and
an explore action in which the agent moves throughout an environment without regard to a destination.

3. The location and navigation module of claim 1, wherein the vote determination module is configured to generate a vote for a particular location also based on a relation between that location and a destination location.

4. The location and navigation module of claim 3, wherein the vote determination module is configured to generate a vote for a particular location also based on a cost associated with the relation.

5. The location and navigation module of claim 1, wherein the vote determination module is configured to generate a vote that directs the agent to perform a multi-hop navigation action in response to comparison between a set of probabilistic beliefs associated with at least one location that is directly linked to a destination location, and a set of probabilistic beliefs associated with at least one location that is indirectly linked to the destination location.

6. The location and navigation module of claim 1, wherein the vote determination module is configured to generate a vote that directs the agent to perform an explore action upon determining that the agent has entered a stuck state, the stuck state being associated with a failure of the agent to make progress toward a destination location.

7. A computer readable medium for storing computer readable instructions, the computer readable instructions providing a location and navigation module when executed by one or more processing devices, the computer readable instructions comprising:
logic configured to receive at least one input image provided by an agent within an environment;
logic configured to compare said at least one input image with a plurality of edge images associated with an edge within a directed graph to produce observations, the edge connecting two nodes in the directed graph and corresponding to a transition path between two locations within the environment; and
logic configured to generate a plurality of probabilistic beliefs for a plurality of respective edge images associated with the edge based on the observations, each probabilistic belief corresponding to a likelihood that the agent is associated with an edge image associated with the edge;
logic configured to provide control instructions which control motion of the agent along the edge based on the probabilistic beliefs.

8. The computer readable medium of claim 7, the computer readable instructions further comprising:
logic configured to use the plurality of probabilistic beliefs to identify a matching edge image that is deemed a most appropriate match for said at least one input image provided by the agent;
logic configured to identify a position of the matching edge image within a sequence of the plurality of edges images associated with the edge; and
logic configured to identify a likely location of the agent along the transition path based on the position.

9. The computer readable medium of claim 7, wherein said logic configured to generate is configured to generate a probabilistic belief for a given edge image by multiplying an observation for the given edge image by a filtering factor that takes into consideration motion of the agent along a transition path associated with the edge.

10. The computer readable medium of claim 7, wherein said logic configured to provide control instructions comprises:
logic configured to determine displacement of at least one feature in said at least one input image from a corresponding at least one feature in at least one of the plurality of edge images, to provide at least one offset,
the control instructions being based on said at least one offset.

11. The computer readable medium of claim 10, wherein said logic configured to determine displacement is configured to determine displacements of a plurality of features in said at least one input image from a correspond plurality of features in the plurality of edge images to provide a plurality of offsets,
wherein said logic configured to provide control instructions further comprises:
logic configured to multiply the plurality of probabilistic beliefs by respective offsets to provide weighted offsets; and
logic configured to combine the weighted offsets to provide a final offset, the control instructions being based on the final offset.

12. A method, using electrical data processing functionality, for identifying a location of an agent, comprising:
receiving a plurality of input images provided by the agent within an environment, including
a front image provided by the agent associated with a visual field in view in front of the agent;
a back image provided by the agent associated with a visual field of view in back of the agent; and
depth-related information provided by the agent that identifies distances between features in the environment and the agent;
comparing at least one of the input images with a collection of graph images associated with a directed graph to produce observations, the directed graph presenting a topological representation of the environment, a first subset of graph images being associated with nodes within the directed graph, and a second subset of graph images being associated with edges between the nodes in the directed graph; and
generating a plurality of probabilistic beliefs for a plurality of respective locations based on the observations, each probabilistic belief corresponding to a likelihood that the agent is associated with a location identified in the directed graph,

13. The method of claim 12, wherein said comparing is operative to select between the front image and the back image based on a determined suitability of the front image and the back image, the suitability of the front image with respect to the back image being based on a determination of whether the agent is at a node location or an edge location.

14. The method of claim 12, wherein said comparing is configured to utilize the depth information as a validity check on comparison results obtained using either the front image or the back image.

15. The method of claim 12, wherein said generating comprises generating a probabilistic belief for a given location by multiplying an observation for the given location by a filtering factor that takes into consideration structure of the environment and an action being performed by the agent.

16. The method of claim 15, further comprising generating the filtering factor by:
multiplying a current probabilistic belief for the given location by transition information, the transition information taking into account the action being performed by the agent and a relationship between a candidate location and the given location, said multiplying producing a weighted current belief;
repeating said multiplying for a plurality of candidate locations to provide a plurality of weighted current beliefs; and
summing the weighted current beliefs to provide the filtering factor.

17. The method of claim 12, further comprising generating the directed graph by manually guiding the agent through the environment as the agent takes images within the environment.

18. The method of claim 12, further comprising using the plurality of probabilistic beliefs to perform navigation within the environment, wherein the navigation within the environment defines a transition path, further comprising updating the directed graph to add a new edge associated with the transition path.

19. The method of claim 18, further comprising modifying transition information based on the navigation, the transition information being used to determine the plurality of probabilistic beliefs.

20. The method of claim 12, further comprising adding a juncture point within the directed graph that partitions at least one edge in the directed graph into two segments.
